(19) United States
(12) Patent Application Publication
(10) Pub. No.: US 2020/0293719 A1
(43) Pub. Date: Sep. 17, 2020

(54) RECOMMENDATION SENTENCE GENERATION DEVICE, RECOMMENDATION SENTENCE GENERATION METHOD, AND RECOMMENDATION SENTENCE GENERATION PROGRAM

(71) Applicant: TOYOTA JIDOSHA KABUSHIKI KAISHA, Toyota-shi (JP)

(72) Inventor: Koichi SUZUKI, Miyoshi-shi (JP)

(73) Assignee: TOYOTA JIDOSHA KABUSHIKI KAISHA, Toyota-shi (JP)

(21) Appl. No.: 16/801,237

(22) Filed: Feb. 26, 2020

(30) Foreign Application Priority Data
Mar. 11, 2019 (JP) 2019-043901

(51) Int. Cl. G06F 40/30; G06N 5/04; G06N 20/00; G06F 40/279; G06F 40/253

(52) U.S. Cl. CPC G06F 40/30; G06N 5/04; G06Q 50/01; G06F 40/279; G06F 40/253; G06N 20/00

(57) ABSTRACT

A recommendation sentence generation device according to the disclosure is a recommendation sentence generation device that generates a recommendation sentence about a facility. This recommendation sentence generation device is equipped with a selection unit that selects document data written about the facility, based on an appearance frequency of a topic word that is associated with the facility, and a correction unit that corrects a predetermined word that is included in the selected document data.

### INCORPORATION BY REFERENCE

The disclosure of Japanese Patent Application No. 2019-043901 filed on Mar. 11, 2019 including the specification, drawings and abstract is incorporated herein by reference in its entirety.

### BACKGROUND

### 1. Technical Field

The disclosure relates to a recommendation sentence generation device, a recommendation sentence generation method, and a recommendation sentence generation program.

### 2. Description of Related Art

Conventionally, there is known an abstract sentence generation device that deletes certain unnecessary words from important sentences extracted by text shaping means and that deletes one or some of the important sentences fulfilling a specific condition (see Japanese Patent Publication No. 7-43717 (JP 7-43717 A)).

### SUMMARY

However, documents that are disseminated with the aid of social network services (SNS) and the like are constituted of sentences written in a free style. Such documents include, for example, signs, pictorial symbols, uniform resource locators (URL), languages other than Japanese, such as English and the like, or include grammatically incorrect sentences. Therefore, each of the sentences in the documents that remains uncorrected is not suitable as, for example, a sentence for recommending a subject matter such as a facility or the like.

It is thus an object of the disclosure to provide a recommendation sentence generation device, a recommendation sentence generation method, and a recommendation sentence generation program that can generate a sentence that is suitable as a recommendation sentence about a subject matter.

A recommendation sentence generation device according to one aspect of the disclosure is a recommendation sentence generation device that generates a recommendation sentence about a subject matter. This recommendation sentence generation device is equipped with a selection unit that selects a document written about the subject matter, based on an appearance frequency of a topic word that is associated with the subject matter, and a correction unit that corrects a predetermined word that is included in the selected document.

A recommendation sentence generation method according to another aspect of the disclosure is a recommendation sentence generation method for generating a recommendation sentence about a subject matter. This recommendation sentence generation method includes a step of selecting a document written about the subject matter, based on an appearance frequency of a topic word that is associated with the subject matter, and a step of correcting a predetermined word that is included in the selected document.

A recommendation sentence generation program according to still another aspect of the disclosure is a recommendation sentence generation program that is executed by a computer to generate a recommendation sentence about a subject matter. This recommendation sentence generation program includes a step of selecting a document written about the subject matter, based on an appearance frequency of a topic word that is associated with the subject matter, and a step of correcting a predetermined word that is included in the selected document.

According to the disclosure, a sentence that is suitable as a recommendation sentence about a subject matter can be generated.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is a configuration diagram showing the general configuration of a recommendation sentence generation device according to one of the embodiments;

FIG. 2 is a view showing the general configuration of facility clusters shown in FIG.

1;

FIG. 3 is a view showing the general configuration of topic clusters shown in FIG. 1;

FIG. 4 is a view showing the data structure of a part-of-speech table shown in FIG. 1;

FIG. 5 is a view showing an example of calculating degrees of importance of sentences that are included in selected document data;

FIG. 6 is a view showing the data structure of a weight table shown in FIG. 1;

FIG. 7 is a view showing another example of calculating degrees of importance of sentences that are included in the selected document data;

FIG. 8 is a view showing the data structure of a fixed conversion table shown in FIG. 1;

FIG. 9 is a view showing the data structure of a random conversion table shown in FIG. 1;

FIG. 10 is a view showing the data structure of an addition table shown in FIG. 1; and

FIG. 11 is a flowchart showing the general operation of the recommendation sentence generation device according to one of the embodiments.

### DETAILED DESCRIPTION OF EMBODIMENTS

One of the embodiments of the disclosure will be described hereinafter. In the drawings that will be mentioned hereinafter, like or similar components or elements are denoted by like or similar reference symbols. It should be noted, however, that the drawings are schematic. Furthermore, the technical scope of the disclosure should not be construed as being limited to those embodiments.

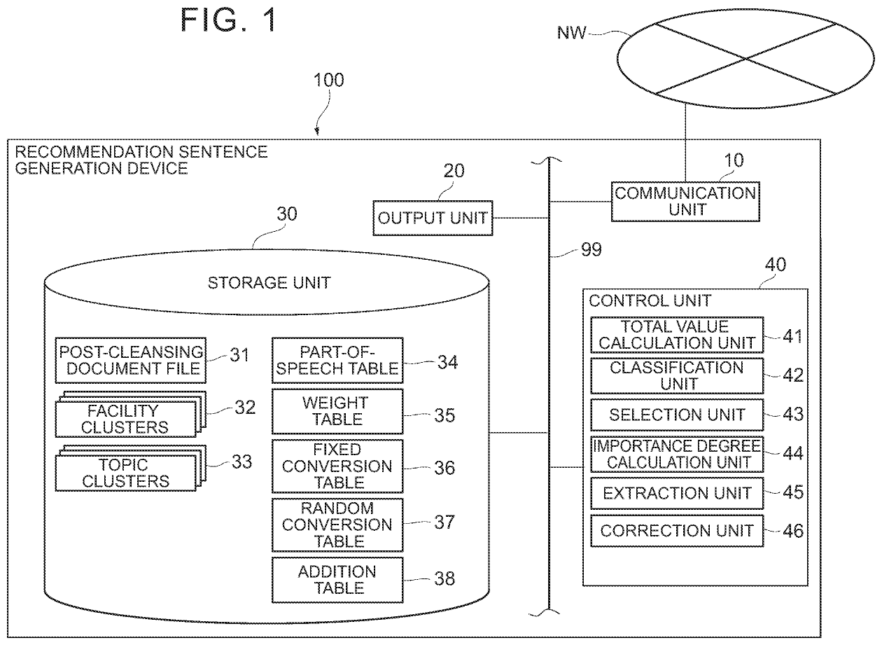

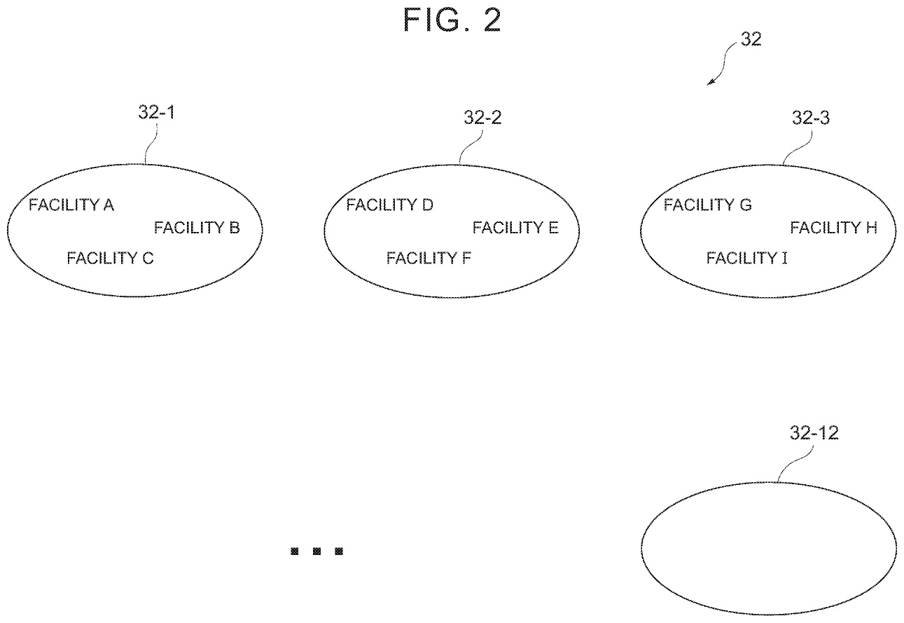

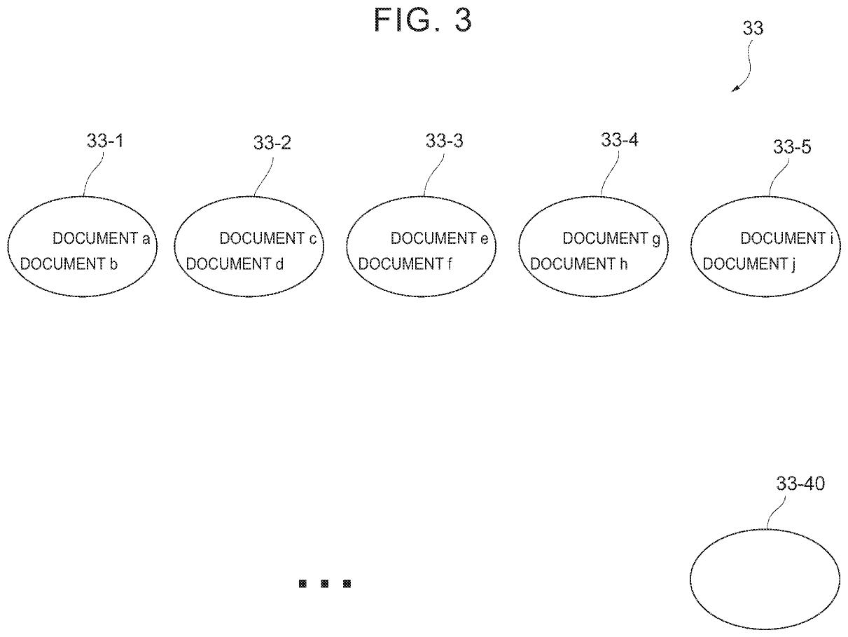

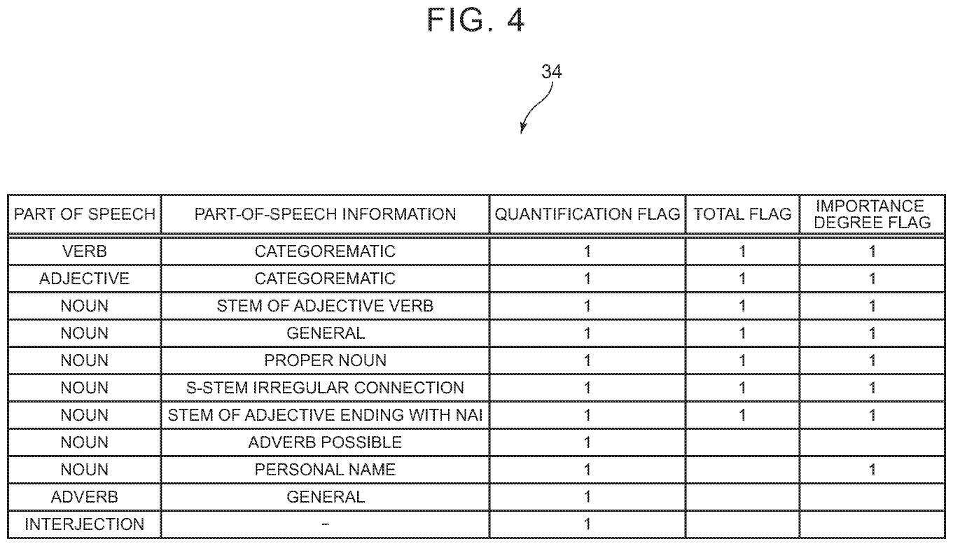

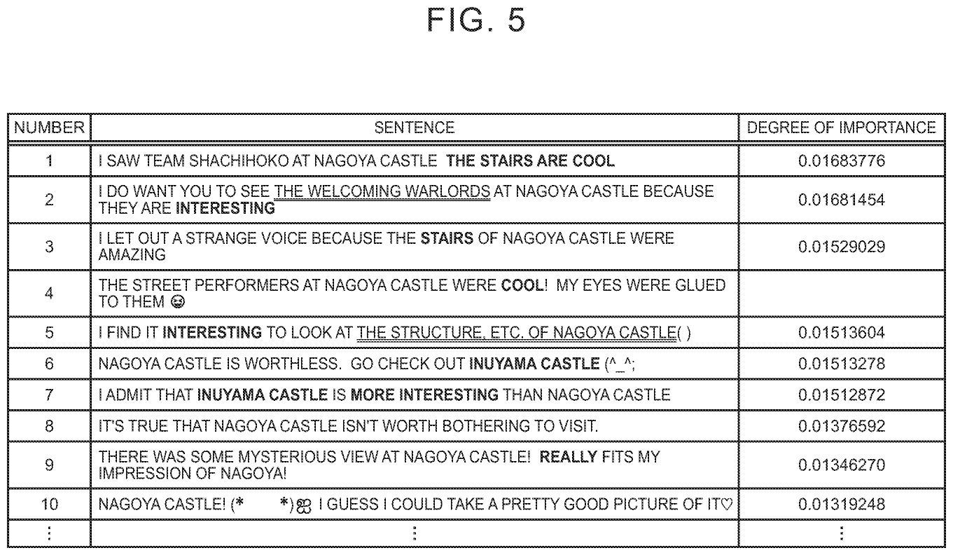

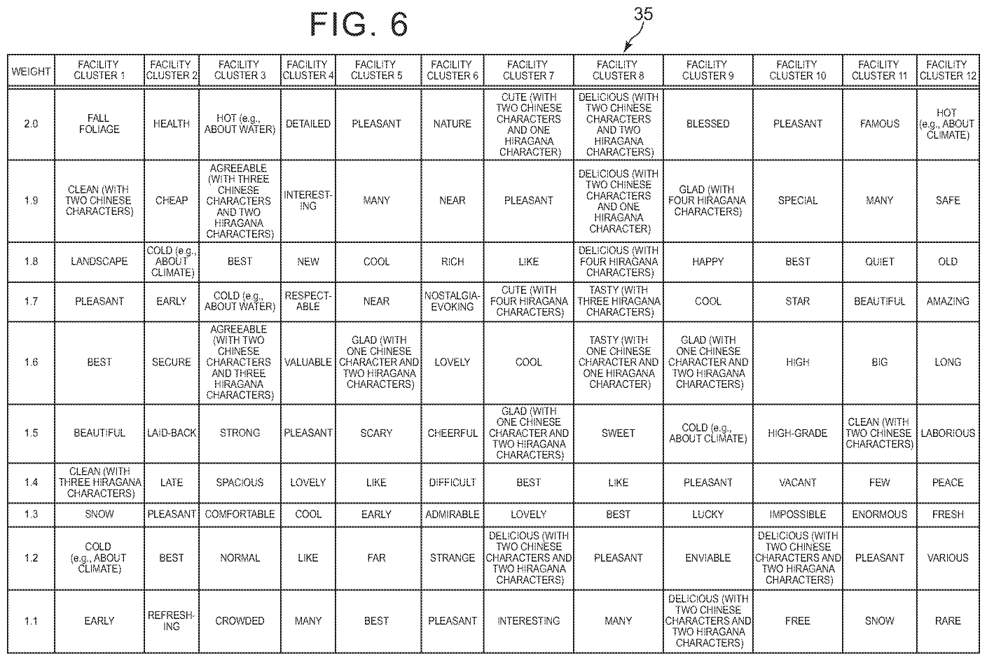

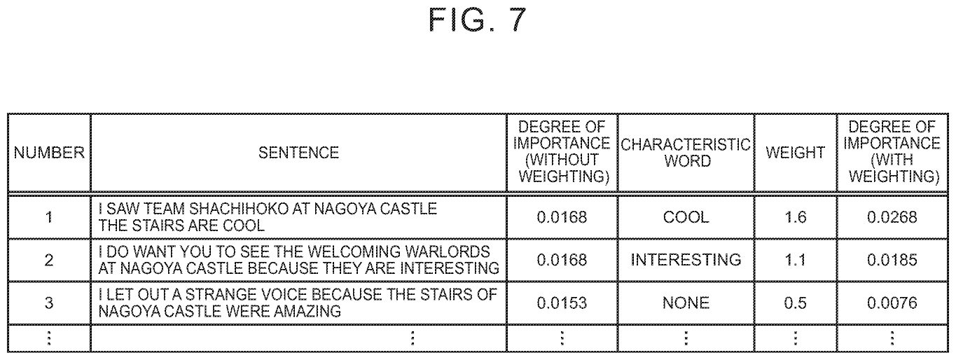

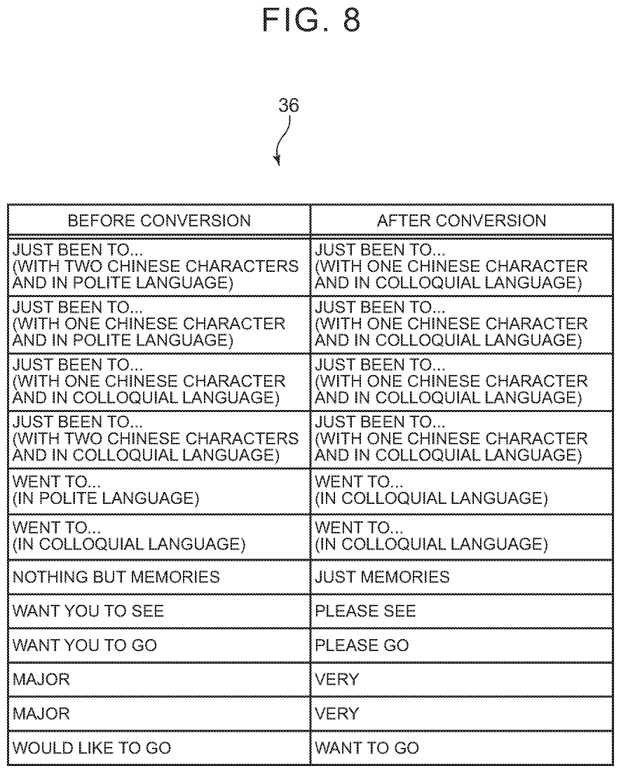

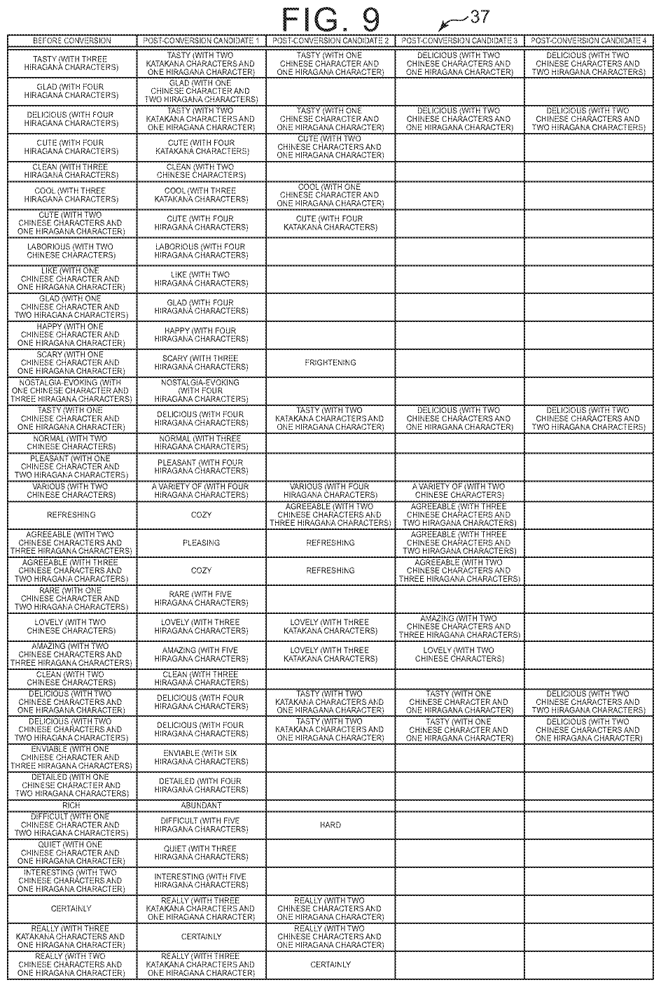

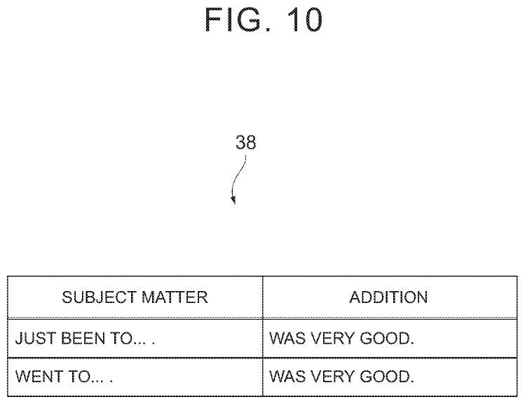

FIGS. 1 to 11 are intended to present a recommendation sentence generation device, a recommendation sentence generation method, and a recommendation sentence generation program according to one of the embodiments. First of all, the general configuration of the recommendation sentence generation device according to one of the embodiments will be described with reference to FIGS. 1 to 10. FIG. 1 is a configuration diagram showing the general configuration of a recommendation sentence generation device 100 according to one of the embodiments. FIG. 2 is a view showing the general configuration of facility clusters 32 shown in FIG. 1. FIG. 3 is a view showing the general configuration of topic clusters 33 shown in FIG. 1. FIG. 4 is a view showing the data structure of a part-of-speech table 34 shown in FIG. 1. FIG. 5 is a view showing an example of calculating degrees of importance of sentences that are included in selected document data. FIG. 6 is a view showing the data structure of a weight table 35 shown in FIG. 1. FIG. 7 is a view showing another example of calculating degrees of importance of sentences that are included in the selected document data. FIG. 8 is a view showing the data structure of a fixed conversion table 36 shown in FIG. 1. FIG. 9 is a view showing the data structure of a random conversion table 37 shown in FIG. 1. FIG. 10 is a view showing the data structure of an addition table 38 shown in FIG. 1.

The recommendation sentence generation device 100 is designed to generate a recommendation sentence (referred to also as a testimonial sentence) about a subject matter such as a facility or the like. The subject matter of the recommendation sentence may not necessarily be a facility, but may be, for example, an event, a place, a space or the like. Incidentally, for the sake of simple explanation, the following description will be given on the assumption that the subject matter of the recommendation sentence is a facility.

As shown in FIG. 1, the recommendation sentence generation device 100 is equipped with, for example, a communication unit 10, an output unit 20, a storage unit 30, and a control unit 40. Besides, the recommendation sentence generation device 100 is further equipped with a bus 99 that is configured to transfer signals and data among respective units of the recommendation sentence generation device 100.

The communication unit 10 is designed to communicate (transmit and receive) data. The communication unit 10 is configured to be able to establish communication via a network NW, based on one or a plurality of predetermined communication systems. In the case where the network NW or another network that is combined with the network NW is the Internet, at least one of the communication systems of the communication unit 10 is a communication system complying with the Internet protocol.

The output unit 20 is configured to output information. The output unit 20 is configured to include, for example, a display device such as a liquid-crystal display, an electro luminescence (EL) display, a plasma display or the like. In the case of this example, the output unit 20 can output information by causing the display device to display text data such as characters, numbers, signs and the like, image data, video data and the like.

The storage unit 30 is configured to store programs, data and the like. The storage unit 30 is configured to include, for example, a hard disk drive, a solid state drive or the like. The storage unit 30 stores in advance various programs that are executed by the control unit 40, data that are needed to execute the programs, and the like.

Besides, the storage unit 30 stores a post-cleansing document file 31, the facility clusters 32, and the topic clusters 33.

The post-cleansing document file 31 is a collection of a plurality of document data. The document data are data on documents that are used for SNS. Besides, the post-cleansing document file 31 includes a plurality of document data after data cleansing. That is, document data that are not needed to generate a recommendation sentence, for example, document data that do not include the contents of recommendation, document data that are unsuitable as recommendation, document data that are considered to be news or notification, document data on the redundant contents, and the like are removed from the post-cleansing document file 31.

The facility clusters 32 are designed to form groups of facilities about which similar impressions or feelings are expressed. As shown in FIG. 2, the facility clusters 32 include, for example, 12 facility clusters 32-1 to 32-12. At least one facility is classified into each of the facility clusters 32-1 to 32-12. For example, the facility cluster 32-1 is a facility cluster about which “delicious” or an impression or feeling similar thereto is expressed, and the facility cluster 32-2 is a facility cluster about which “clean” or an impression or feeling similar thereto is expressed. By thus aggregating facilities as subject matters of a recommendation sentence into some groups each making a similar impression, the efficiency can be made higher than in the case where each of the facilities is considered, through omission of common processes, reduction of the number of times of repetition, and the like. The facility clusters 32-1 to 32-12 will be comprehensively referred to hereinafter as “the facility clusters 32”.

The topic clusters 33 are designed to form groups of documents each including a topic in the same direction. As shown in FIG. 3, the topic clusters 33 include, for example, 40 topic clusters 33-1 to 33-40. The topic clusters 33-1 to 33-40 are formed for each of the facility clusters 32. In consequence, the document data that are included in the post-cleansing document file are each classified into one of the facility clusters 32-1 to 32-12, and are each classified also into one of the topic clusters 33-1 to 33-40 (12×40=480 classifications). For example, the topic cluster 33-1 is a topic cluster regarding “delicious”, the topic cluster 33-2 is a topic cluster regarding “good cost-effectiveness/sense of fullness”, and the topic cluster 33-3 is a topic cluster regarding “sweet/dessert”. Besides, for example, the topic cluster 33-4 is a topic cluster regarding “crowded/reservation”, and the topic cluster 33-5 is a topic cluster regarding “stylish/clean”. By thus aggregating the document data into groups each including a topic in the same direction, the group of the topic that is associated with the facility in the document data can be specified. The topic clusters 33-1 to 33-40 will be comprehensively referred to hereinafter as “the topic clusters 33”.

Returning to the description of FIG. 1, the storage unit 30 further stores the part-of-speech table 34, the weight table 35, the fixed conversion table 36, the random conversion table 37, and the addition table 38. These tables will be described later.

Returning to the description of FIG. 1, the control unit 40 is configured to control the operations of the respective units of the recommendation sentence generation device 100, such as the communication unit 10, the output unit 20, the storage unit 30 and the like. Besides, the control unit 40 is configured to realize respective functions that will be described later, by, for example, executing the programs stored in the storage unit 30. The control unit 40 is configured to include, for example, a processor such as a central processing unit (CPU), an application specific integrated circuit (ASIC), a field programmable gate array (FPGA) or the like, a memory such as a read only memory (ROM), a random access memory (RAM) or the like, and a buffer memory device such as a buffer or the like.

Besides, the control unit 40 is equipped, as its functional configuration, with, for example, a total value calculation unit 41, a classification unit 42, a selection unit 43, an importance degree calculation unit 44, an extraction unit 45, and a correction unit 46.

The total value calculation unit 41 is configured to quantify words of predetermined parts of speech that are included in the document data, and calculate a total value of the document data.

In concrete terms, the total value calculation unit 41 divides each of the document data that are included in the post-cleansing document file into columns of morphemes through a morphological analysis, and determines a part of speech of each of the morphemes. Subsequently, the total value calculation unit 41 extracts predetermined parts of speech, for example, parts of speech that are lexically meaningful, and more specifically, words as nouns, verbs, adjectives, adjective verbs, adverbs, and interjections, in each of the document data, through the use of the part-of-speech table 34 stored in the storage unit 30. In other words, the total value calculation unit 41 removes functional words that are grammatically meaningful, for example, particles, auxiliary verbs, and the like.

As shown in FIG. 4, the part-of-speech table 34 stores a quantification flag, a total flag, and an importance degree flag as one record, for each part of speech and each piece of part-of-speech information. The total value calculation unit 41 extracts, from the document data, at least one word coinciding with each part of speech and each piece of part-of-speech information whose quantification flag is “1”. In the case where there are a plurality of coinciding words, the total value calculation unit 41 extracts all those words from the document data.

Returning to the description of FIG. 1, the total value calculation unit 41 subsequently quantifies a meaning of each extracted word, based on a relationship among appearance positions of neighboring words in the document data, through the use of a classifier (not shown) generated through mechanical learning. The classifier that is used in quantifying the meaning of each word is generated through, for example, a method (which is also referred to as “an algorithm” or “a model”, and the same will hold true hereinafter) such as Word2Vec that expresses each word as a vector, or the like. Incidentally, the classifier may be generated by the recommendation sentence generation device 100, or may be generated by another device and received via the network NW and the communication unit 10.

Subsequently, the total value calculation unit 41 extracts words coinciding with each part of speech and each piece of part-of-speech information whose total flag is “1”, in each of the document data, through the use of the part-of-speech table 34 shown in FIG. 4. Subsequently, the total value calculation unit 41 calculates a total value by summating numerical values of the respective extracted words, in the document data. Thus, the total value of each of the document data is calculated, and the contents that are mentioned by each of the document data are quantified.

Incidentally, in the present application, the term “word” is at least required to be shorter than a sentence, and is used with a meaning including a morpheme, a single word, an expression, a phrase and the like.

The classification unit 42 is configured to classify the document data into one of the plurality of the topic clusters 33-1 to 33-40, based on topic words that are associated with facilities. The topic words that are associated with the facilities are “delicious (with two Chinese characters and two hiragana characters)” or words similar thereto, in the example of the foregoing topic cluster 33-1. As the words similar to “delicious (with two Chinese characters and two hiragana characters)”, it is possible to mention, for example, “delicious (with two Chinese characters and one hiragana character)”, “delicious (with four hiragana characters)”, “tasty (with three hiragana characters)”, “tasty (with one Chinese character and one hiragana character)”, “sweet”, “like”, “best”, “pleasant”, “many” and the like.

More specifically, the classification unit 42 is configured to classify each of the document data into one of the plurality of the topic clusters, based on the calculated total value. In this manner, the total values of the document data including the topic words that are associated with one another are made close to one another, by quantifying the words of predetermined parts of speech that are included in the document data respectively, and calculating the total values of the document data respectively. Therefore, the accuracy in classifying the document data into the topic clusters 33 respectively can be enhanced based on the total values.

In concrete terms, the classification unit 42 classifies each of the document data into one of the 40 topic clusters 33-1 to 33-40 shown in FIG. 3, through the use of an unsupervised data classification method, for example, a k-average method (which is also referred to as k-means clustering). In this manner, supervised data are not required, and the classification of the document data into the topic clusters 33 is facilitated, by using the unsupervised data classification method.

The selection unit 43 is configured to select document data written about each facility, based on appearance frequencies of the foregoing topic words. In this manner, document data that are suitable as a recommendation sentence about each facility can be selected based on the appearance frequencies of the topic words that are associated with each facility.

More specifically, the selection unit 43 is configured to determine at least one main topic cluster from among the plurality of the topic clusters 33-1 to 33-40, based on the number of classified document data, and select document data classified into the at least one main topic cluster.

In concrete terms, the selection unit 43 counts the number of document data classified into each of the topic clusters 33-1 to 33-40 for each of the facilities, and determines the top three topic clusters and topic clusters containing two or more document data, as main topic clusters. Then, the selection unit 43 selects the document data classified into the main topic clusters. In the case where there are a plurality of document data classified into the main topic clusters, the selection unit 43 selects all those document data. In this manner, the document data written about the main topics regarding each of the facilities are selected by determining the main topic clusters from among the plurality of the topic clusters 33-1 to 33-40 based on the number of classified document data, and selecting the document data classified into the main topic clusters. Therefore, document data that are more suitable as a recommendation sentence about each of the facilities can be selected.

The importance degree calculation unit 44 is configured to calculate a degree of importance of each sentence that is included in the selected document data, based on a word that is commonly used among a plurality of sentences in the selected document data.

It should be noted herein that the degree of importance indicates the reliability of information and is an index for extracting an important sentence from the document data. The important sentence is a sentence that is suited to generate a recommendation sentence about a facility as a subject matter. For example, the important sentence is a sentence that contains highly reliable information, that contains a large quantity of information, and that includes an impression or evaluation representing the characteristics of the facility.

In concrete terms, the importance degree calculation unit 44 divides the document data selected by the selection unit 43 into sentences based on delimiter characters, for example, stop marks, periods, exclamation marks, question marks, spaces and the like. In the case where one sentence obtained through division fulfills a predetermined condition, the importance degree calculation unit 44 generates a sentence by coupling that one sentence with a subsequent sentence when that one sentence is the first sentence in the document data, and coupling that one sentence with an immediately preceding sentence when that one sentence is not the first sentence in the document data. On the other hand, in the case where one sentence obtained through division does not fulfill the predetermined condition, the importance degree calculation unit 44 generates a sentence by directly using that one sentence. The predetermined condition is, for example, that the number of characters in one sentence is smaller than a predetermined value, and/or that there is only an expression of impressions in one sentence as a result of a morphological analysis.

Incidentally, in the present application, the term “sentence” includes one sentence, or a series of meaningful sentences including two sentences that are obtained by coupling one sentence and one sentence with each other.

Also, the importance degree calculation unit 44 calculates a degree of importance of each sentence in the selected document data. The degree of importance of each sentence is calculated through the use of a method in which the degree of importance increases as the number of words that are commonly used among all the sentences included in the selected document data increases, for example, Lex Rank or the like. In this manner, the degree of importance indicating the reliability of information can be easily calculated by calculating the degree of importance of each sentence that is included in the selected document data, based on words that are commonly used among a plurality of sentences in the selected document data.

Besides, the importance degree calculation unit 44 is configured to calculate the degree of importance of each sentence that is included in the selected document data, based further on the quantity of additional information associated with each facility.

For example, when degrees of importance of sentences in the selected document data are individually calculated as to the facility “Nagoya Castle”, a result as shown in FIG. 5 is obtained. The degree of importance of a sentence including many elements that are common among a plurality of sentences, such as “stairs”, “cool”, “interesting”, “Inuyama Castle” and the like as indicated in bold font in FIG. 5 is high.

Besides, the degree of importance of a sentence including many pieces of additional information such as “the welcoming warlords”, “the structure of Nagoya Castle” and the like as underlined in FIG. 5 is higher than the degree of importance of a sentence simply including “interesting”. In this manner, the degree of importance of a sentence including a large quantity of additional information can be made high, and the degree of importance can be made to reflect the largeness of the quantity of additional information, by calculating the degree of importance of each sentence that is included in the selected document data, based further on the quantity of additional information that is associated with the facility.

Furthermore, the importance degree calculation unit 44 is configured to calculate the degree of importance of each sentence that is included in the selected document data, through the use of a weight corresponding to each characteristic word that is associated with each facility.

In concrete terms, when a characteristic word that is associated with each facility is included in each sentence in the selected document data, the importance degree calculation unit 44 carries out weighting, namely, multiplication by the weight corresponding to the characteristic word, through the use of the part-of-speech table 34 stored in the storage unit 30. In the present embodiment, the characteristic word that is associated with each facility is a word expressing an impression and an evaluation that represent the characteristics of each facility that is classified into each of the facility clusters 32-1 to 32-12.

As shown in FIG. 6, values of weights, and characteristic words corresponding to the weights are stored in the weight table 35, for each of the facility clusters 32-1 to 32-12. Incidentally, “a facility cluster i (i is an integer from 1 to 12)” shown in FIG. 6 corresponds to a facility cluster 32-j (j is an integer from 1 to 12). Incidentally, a weight may be stored into the storage unit 30 for a word that represents recommendation and that is commonly used among the facilities of the respective facility clusters 32-1 to 32-12.

For example, in the case where the foregoing facility “Nagoya Castle” is classified into the facility cluster 32-7, a sentence numbered as “1” includes a characteristic word “cool” of a weight “1.6”. Therefore, the importance degree calculation unit 44 calculates a weighted degree of importance “0.0268” by multiplying an unweighted degree of importance by the weight. By the same token, a sentence numbered as “2” includes a characteristic word “interesting” of a weight “1.1”. Therefore, the importance degree calculation unit 44 calculates a weighted degree of importance “0.0185” by multiplying an unweighted degree of importance by the weight. On the other hand, the sentence numbered as “2” does not include any characteristic word of the facility cluster 32-7. In this case, the importance degree calculation unit 44 calculates a weighted degree of importance “0.0076” by multiplying an unweighted degree of importance by, for example, a weight “0.5”. In this manner, the degree of importance of a sentence that includes a characteristic word can be made high, and the degree of importance can be made to reflect the presence/absence of an impression of the facility, an evaluation of the facility, and a word expressing recommendation of the facility, by calculating the degree of importance of each sentence that is included in the selected document data, through the use of the weight corresponding to the characteristic word that is associated with the facility.

The extraction unit 45 is configured to extract an important sentence from the selected document data, based on a degree of importance.

In concrete terms, the extraction unit 45 extracts a sentence with the highest degree of importance in the selected document data, as an important sentence. Thus, the important sentence with the highest degree of importance is extracted for each of the facilities.

The correction unit 46 is configured to correct a predetermined word that is included in the selected document data. It should be noted herein that the inventor of the disclosure has found out that a sentence is realized by correcting a predetermined word in the sentence. In consequence, a sentence that is suitable as a recommendation sentence about a facility can be generated by correcting the predetermined word in the selected document data, which are suited for the recommendation sentence about the facility.

More specifically, the correction unit 46 is configured to correct the predetermined word that is included in the extracted important sentence. In this manner, a sentence that is more suitable as a recommendation sentence about a facility can be generated by correcting an important sentence with high reliability of information, through correction of the predetermined word that is included in the extracted important sentence.

In concrete terms, the correction unit 46 first deletes a predetermined expression if this predetermined expression is at the beginning of the important sentence. The predetermined expression includes, for example, a sign, a word of a predetermined part of speech such as an interjection, a conjunction, a particle or the like, and an expression regarding date and time, such as “yesterday”, “today”, “last week”, “this week” or the like.

Subsequently, the correction unit 46 converts a predetermined word that is included in a pre-correction important sentence into another predetermined word, through the use of the fixed conversion table 36 stored in the storage unit 30.

As shown in FIG. 8, the fixed conversion table 36 is a table that pairs a pre-conversion word and a post-conversion word with each other. In the case where there is a word stored in a pre-conversion column in or at the end of the pre-correction important sentence, the correction unit 46 converts the word into a word stored in a post-conversion column in a corresponding row. For example, “just been to . . . (with two Chinese characters and in polite language)” in or at the end of the pre-correction important sentence is converted into “just been to . . . (with one Chinese character and in colloquial language)”.

Besides, the correction unit 46 randomly converts a predetermined word that is included in a pre-correction important sentence into one of a plurality of other predetermined words, through the use of the random conversion table 37 stored in the storage unit 30.

As shown in FIG. 9, the random conversion table 37 is a table that pairs a pre-conversion word with a plurality of post-conversion words. In the case where there is a word stored in a pre-conversion column in or at the end of the pre-correction important sentence, the correction unit 46 randomly converts the word into a word stored in one of a column of a post-conversion candidate 1, a column of a post-conversion candidate 2, a column of a post-conversion candidate 3, or a column of a post-conversion candidate 4 , in a corresponding row. For example, “tasty (with three hiragana characters)” in or at the end of the pre-correction important sentence is converted into “tasty (with two katakana characters and one hiragana character)”, “tasty (with one Chinese character and one hiragana character)”, “delicious (with two Chinese characters and one hiragana character)”, or “delicious (with two Chinese characters and two hiragana characters)”. In the case where the number of post-conversion candidates is smaller than four, the word is randomly converted into a word within a range corresponding to the number of post-conversion candidates.

Subsequently, in the case where there is a question mark or a stop mark at the end of an important sentence, the correction unit 46 leaves the end of the important sentence as it is. Otherwise, the correction unit 46 adds a stop mark to the end of the important sentence. Then, in the case where there is a predetermined word at the end of a post-correction important sentence, the correction unit 46 adds another predetermined word thereto, through the use of the addition table 38 stored in the storage unit 30.

As shown in FIG. 10, the addition table 38 is a table that pairs a target word and an additional word with each other. In the case where there is a word stored in a target column at the end of the post-correction important sentence, the correction unit 46 adds a word stored in an additional column thereto in a corresponding row. For example,

“(It) was very good.” is added to “(I've) just been to . . . ” at the end of the post-correction important sentence, which results in “(I've) just been to . . . (It) was very good.” Besides, “(It) was very good.” is added to “(I) went to . . . ” at the end of the post-correction important sentence, which results in “(I) went to . . . (It) was very good.” In this manner, the correction unit 46 carries out at least one of fixed conversion for converting a predetermined word into another predetermined word, random conversion for randomly converting a predetermined word into one of a plurality of other predetermined words, and addition for adding another predetermined word to a predetermined word. As a result, a sentence that is suitable as a recommendation sentence about each facility can be easily generated.

The respective functions of the control unit 40 can be realized by a program that is executed by a computer (a microprocessor). Accordingly, the respective functions with which the control unit 40 is endowed can be realized by a piece of hardware, a piece of software, or a combination of a piece of hardware and a piece of software, and should not be limited to any one of them.

Besides, in the case where the respective functions of the control unit 40 are realized by a piece of software or a combination of a piece of hardware and a piece of software, their processes can be performed in a multitask manner, in a multithread manner, or both in a multitask manner and in a multithread manner, and should not be limited to any one of them.

Incidentally, the post-cleansing document file 31, the facility clusters 32, the topic clusters 33, the part-of-speech table 34, the weight table 35, the fixed conversion table 36, the random conversion table 37, and the addition table 38 should not be limited in structure and format to the foregoing examples. For example, each of the post-cleansing document file 31, the facility clusters 32, the topic clusters 33, the part-of-speech table 34, the weight table 35, the fixed conversion table 36, the random conversion table 37, and the addition table 38 may be mere data or a database. Besides, in the case where at least one of the post-cleansing document file 31, the facility clusters 32, the topic clusters 33, the part-of-speech table 34, the weight table 35, the fixed conversion table 36, the random conversion table 37, and the addition table 38 is a database, the group units of data may be segmentalized through normalization.

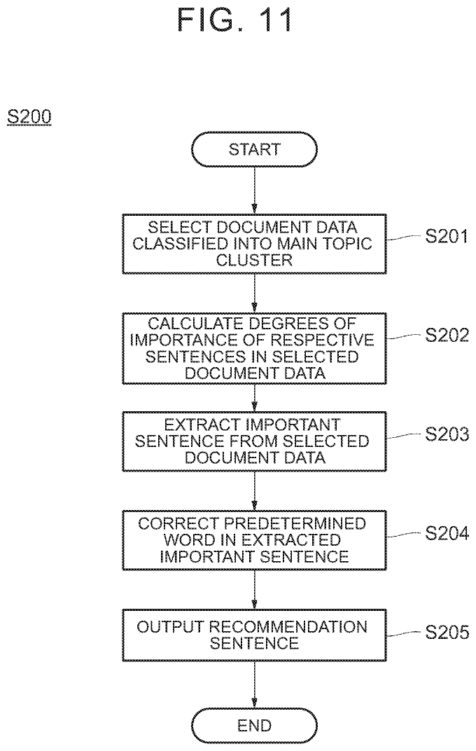

Next, the general operation of the recommendation sentence generation device according to one of the embodiments will be described with reference to FIG. 11. FIG. 11 is a flowchart showing the general operation of the recommendation sentence generation device 100 according to one of the embodiments.

For example, when a plurality of document data that are included in the post-cleansing document file 31 are each classified into one of the plurality of the topic clusters 33-1 to 33-40, the recommendation sentence generation device 100 performs a recommendation sentence generation process S200 shown in FIG. 11.

Incidentally, in the following description, it is assumed that the document data are each classified into one of the plurality of the topic clusters 33-1 to 33-40.

First of all, the selection unit 43 determines a main topic cluster from among the plurality of the topic clusters 33-1 to 33-40, based on the number of classified document data, and selects the document data classified into the main topic cluster (S201).

Subsequently, the importance degree calculation unit 44 calculates a degree of importance of each sentence in the document data selected in step S201, based on a word that is commonly used among a plurality of sentences in the document data selected in step S201 (S202).

Subsequently, the extraction unit 45 extracts an important sentence from the document data selected in step S201, based on the degree of importance calculated in step S202 (S203).

Subsequently, the correction unit 46 corrects a predetermined word in the important sentence extracted in step S203 (S204). Thus, a recommendation sentence about a facility is generated.

Subsequently, the correction unit 46 outputs the recommendation sentence generated through step S204 to the output unit 20 (S205). Incidentally, the correction unit 46 may transmit the recommendation sentence generated through step S204 to another device via the communication unit 10 and the network NW, instead of or in addition to outputting the recommendation sentence generated through step S204 to the output unit 20.

In the present embodiment, there is presented an example in which the document data that are included in the post-cleansing document file 31 are each classified into one of the plurality of the topic clusters 33-1 to 33-40 before the start of the recommendation sentence generation process S200, but the disclosure should not be limited thereto. The document data that are included in the post-cleansing document file 31 may be classified into the plurality of the topic clusters 33-1 to 33-40 respectively, as a step (a procedure) in the recommendation sentence generation process S200.

The exemplary embodiment of the disclosure has been described above. With the recommendation sentence generation device 100, the recommendation sentence generation method, and the recommendation sentence generation program according to the present embodiment, the document data written about the facility are selected based on the appearance frequency of the topic word that is associated with the facility. Thus, the document data that are suited for the recommendation sentence about the facility can be selected. Besides, the predetermined word that is included in the selected document data is corrected. It should be noted herein that the inventor of the disclosure has found out that the sentence is realized by correcting the predetermined word in the sentence. In consequence, the sentence that is suitable as the recommendation sentence about the facility can be generated by correcting the predetermined word in the selected document data, which are suitable for the recommendation sentence about the facility.

The embodiment described above is intended to facilitate the understanding of the disclosure, and is not intended to construe the disclosure in any restrictive manner. The respective elements provided in the embodiment, and the arrangement, materials, conditions, shapes, sizes and the like thereof should not be limited to the exemplified ones, but can be appropriately changed. Besides, configurations presented in different embodiments can be partially replaced or combined with one another.

What is claimed is:

1. A recommendation sentence generation device that generates a recommendation sentence about a subject matter, comprising:
a selection unit that selects a document written about the subject matter, based on an appearance frequency of a topic word that is associated with the subject matter; and
a correction unit that corrects a predetermined word that is included in the selected document.

2. The recommendation sentence generation device according to claim 1, further comprising:
an extraction unit that extracts an important sentence from the selected document, based on a degree of importance indicating reliability of information, wherein
the correction unit corrects the predetermined word that is included in the important sentence.

3. The recommendation sentence generation device according to claim 2, further comprising:
an importance degree calculation unit that calculates the degree of importance of a sentence that is included in the selected document, based on a word that is commonly used among a plurality of sentences in the selected document.

4. The recommendation sentence generation device according to claim 3, wherein
the importance degree calculation unit calculates the degree of importance of the sentence that is included in the selected document, based further on a quantity of additional information that is associated with the subject matter.

5. The recommendation sentence generation device according to claim 3, wherein
the importance degree calculation unit calculates the degree of importance of the sentence that is included in the selected document, using a weight corresponding to a characteristic word that is associated with the subject matter.

6. The recommendation sentence generation device according to claim 1, wherein
the correction unit carries out at least one of fixed conversion for converting the predetermined word into another predetermined word, random conversion for converting the predetermined word into one of a plurality of other predetermined words, and addition for adding another predetermined word to the predetermined word.

7. The recommendation sentence generation device according to claim 1, further comprising:
a classification unit that classifies the document into one of a plurality of topic clusters, based on the topic word, wherein
the selection unit determines a main topic cluster from among the plurality of the topic clusters, based on a number of classified documents, and selects a document classified into the main topic cluster.

8. The recommendation sentence generation device according to claim 7, further comprising:
a total value calculation unit that quantifies words of each predetermined part of speech that is included in the document, and that calculates a total value of the document, wherein
the classification unit classifies the document into one of the plurality of the topic clusters, based on the total value.

9. The recommendation sentence generation device according to claim 7, wherein the classification unit classifies the document into one of the plurality of the topic clusters, through use of an unsupervised data classification method.

10. A recommendation sentence generation method for generating a recommendation sentence about a subject matter, comprising:
a step of selecting a document written about the subject matter, based on an appearance frequency of a topic word that is associated with the subject matter; and
a step of correcting a predetermined word that is included in the selected document.

11. A recommendation sentence generation program that is executed by a computer to generate a recommendation sentence about a subject matter, comprising:
a step of selecting a document written about the subject matter, based on an appearance frequency of a topic word that is associated with the subject matter; and
a step of correcting a predetermined word that is included in the selected document.
